(19) United States
(12) Patent Application Publication
(10) Pub. No.: US 2026/0220470 A1
(43) Pub. Date: Jul. 30, 2026

(54) NEURO-SYMBOLIC SYSTEM FOR SOLVING REASONING TASKS

(71) Applicant: GDM Holding LLC, Mountain View, CA (US)

(72) Inventors: Hoang Trieu Trinh, Jersey City, NJ (US); Iurii Chervonyi, Sunnyvale, CA (US); Xiaomeng Yang, Sunnyvale, CA (US); Miroslav Olsak, Cambridge (GB); Hoang Huy Nguyen, Mountain View, CA (US); Junehyuk Jung, Chestnut Hill, MA (US); Thang Minh Luong, Mountain View, CA (US); Quoc V. Le, Sunnyvale, CA (US)

(21) Appl. No.: 19/041,882

(22) Filed: Jan. 30, 2025

(51) Int. Cl. G06N 3/088; G06F 16/903

(52) U.S. Cl. CPC G06N 3/088; G06F 16/90335

(57) ABSTRACT

Methods, systems, and apparatus, including computer programs encoded on a computer storage medium, for a neural-symbolic system for reasoning tasks. One of the methods includes performing multiple different search processes in parallel using a symbolic engine and a neural network model to find a solution to a reasoning task, wherein performing the search process includes: processing, using the neural network model, an input including: (i) data for the reasoning task, and (ii) one or more auxiliary data items generated at one or more previous iterations to generate an auxiliary data item at a current iteration; and generating, using the symbolic engine, states for the reasoning task using the auxiliary data items; maintaining a subset of the states for the reasoning task generated during the multiple different search processes; and sharing the subset of the states for the reasoning task across the multiple different search processes.

### BACKGROUND

This specification relates to solving reasoning tasks using generative models.

Reasoning tasks involve answering questions or solving problems by analyzing information, identifying relationships, and drawing logical conclusions based on given premises. Some reasoning tasks relate to logical reasoning and search through a large space of actions using a model or specification of the problem to be solved. Automated reasoning can be used in applications like planning systems, robotics, and expert systems.

Generative models have demonstrated state of the art performance across a wide range of tasks, such as text generation (e.g., writing, summarization, translation, coding), image generation, and audio generation. Some generative models use very large neural network models that are trained on vast amounts of data. For example, a large language model (LLM) can include a transformer-based neural network model with self-attention capabilities and can achieve general-purpose language understanding and generation in response to a query. Thus, generative models are being deployed in various systems, platforms, or applications, e.g., as a coding assistant, as an email writing assistant, and for generating images in a presentation.

### SUMMARY

Some automated reasoning systems can solve reasoning tasks by combining a symbolic engine and a generative language model. The generative language model can generate multiple alternative auxiliary data items for the reasoning task. An auxiliary data item is not part of a problem statement of a reasoning task. An auxiliary data item can be introduced to assist the reasoning process by allowing for intermediate calculations or representing complex relationships. For example, in geometry, an auxiliary construction can be an extra line or circle that can be used to solve a problem or prove a concept.

Some automated reasoning systems can perform a beam search over alternative auxiliary data items using a symbolic engine. A symbolic engine uses logical rules and symbolic representations to process information, make inferences, and solve problems based on structured knowledge. A beam search is a search algorithm that finds a solution by exploring a graph and expanding the most promising nodes in the graph. The systems can use the symbolic engine to determine states for the reasoning task, e.g., partial solutions to the reasoning task, based on the auxiliary data items generated by the generative language model. The systems can search for a solution to the reasoning task based on the partial solutions.

However, for some reasoning tasks, the search space for the auxiliary data items can be quite large. Thus, the systems that use a simple beam search may be inefficient and slow to find the final solution. In some cases, in fact, the system may not be able to find a solution to the reasoning task. Furthermore, because each node in the beam search works in isolation, states for the reasoning task (e.g., partial solutions) that are derived from one node are not shared with another node in the beam search tree. Thus, the search for a solution can include duplicated derivations or deductions of partial solutions, and computational resources are not used efficiently.

This specification describes systems and techniques for a neuro-symbolic system for solving reasoning tasks by performing multiple different search processes with shared states. In particular, the system can run several different beam searches in parallel and can share the result of the different beam searches across the beam searches through a knowledge sharing mechanism.

In general, one innovative aspect of the subject matter described in this specification can be embodied in methods that include the actions of performing multiple different search processes in parallel using a symbolic engine and a neural network model to find a solution to a reasoning task, wherein each search process of the multiple different search processes includes multiple iterations, and at each iteration, performing the search process includes: processing, using the neural network model, an input including: (i) data for the reasoning task, and (ii) one or more auxiliary data items generated at one or more previous iterations to generate an auxiliary data item at a current iteration; and generating, using the symbolic engine, states for the reasoning task using the auxiliary data items at the current iteration and at the one or more previous iterations; maintaining a subset of the states for the reasoning task generated during the multiple different search processes; and sharing the subset of the states for the reasoning task across the multiple different search processes.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. At one iteration, performing the search process includes: after generating the states for the reasoning task using the auxiliary data items at the current iteration and at the one or more previous iterations, determining whether one of the states corresponds to the solution to the reasoning task; in response to determining that one of the states corresponds to the solution to the reasoning task, terminating the multiple different search processes; and providing data describing the solution to the reasoning task for processing. At another iteration, performing the search process includes: after generating the states for the reasoning task using the auxiliary data items at the current iteration and at the one or more previous iterations, determining whether one of the states corresponds to the solution to the reasoning task; in response to determining that none of the states corresponds to the solution to the reasoning task, selecting, from the states generated using the symbolic engine during the current iteration, a subset of the states for the reasoning task; and adding the selected subset of the states to the subset of the states being maintained and shared across the multiple different search processes. The reasoning task is a mathematical problem, and the auxiliary data item is an auxiliary construction for the mathematical problem. The multiple different search processes use different sampling strategies when using the neural network model to generate the auxiliary data item at the current iteration. The multiple different search processes use different search widths, different search depths, or both. The subset of the states for the reasoning task is independent of the auxiliary data items at the current iteration and at the one or more previous iterations. At each iteration of each search process of the multiple different search processes, generating, using the symbolic engine, the states for the reasoning task includes: generating, using the symbolic engine, the states for the reasoning task using (i) the auxiliary data items at the current iteration and at the one or more previous iterations, and (ii) the subset of the states generated during the one or more previous iterations of the search process and generated by one or more other search processes of the multiple different search processes. The multiple different search processes include multiple different beam search trees, and each iteration is a node of a beam search tree of the multiple different beam search trees.

Particular embodiments of the subject matter described in this specification can be implemented so as to realize one or more of the following advantages.

Rather than using a single search process to search for a solution, the systems and techniques described in this specification can efficiently explore different parts of a search space by deploying different search processes in parallel and allowing the different search processes to share with each other the states for the reasoning task they managed to generate. The systems and methods can save computational resources, such as memory and processing power, by generating solutions to reasoning tasks more efficiently and quickly. Rather than saving all the states generated by the multiple search processes, the systems and methods can save memory and computation by only choosing a subset of the generated states that are not about a specific auxiliary data item, but broadly relevant to the reasoning task. In this way, the subset of the generated states can be useful for other searches in the same search process and across different search processes.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of a neuro-symbolic system.

FIG. 2 is a diagram of a neuro-symbolic system for solving geometry problems.

FIG. 3 is a flow chart of an example process for performing multiple different search processes in parallel.

FIG. 4 is a flow chart of an example process for performing a search at one iteration of a search process.

Like reference numbers and designations in the various drawings indicate like elements.

### DETAILED DESCRIPTION

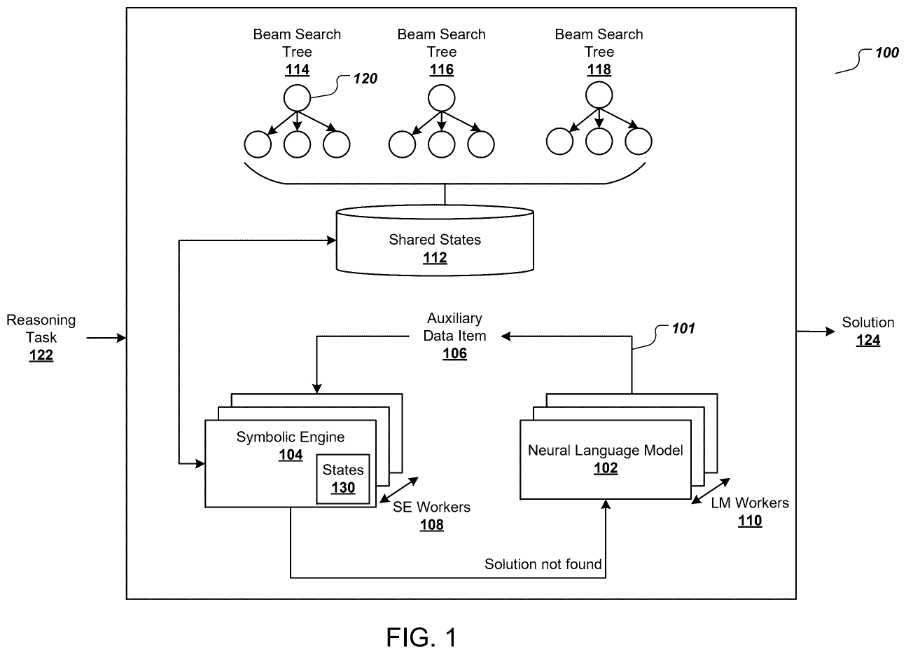

FIG. 1 is a diagram of a neuro-symbolic system 100 for generating a solution 124 to reasoning tasks 122.

Reasoning tasks involve answering questions or solving problems by analyzing information, identifying relationships, and drawing logical conclusions based on given premises.

The reasoning task 122 can be applied to many applications, such as planning systems, robotics, expert systems, formal verification, and theorem proving. For example, the reasoning task 122 can include planning complex sequences of actions to achieve goals by reasoning through possible outcomes. In robotics, solving the reasoning task 122 can allow robots to make decisions and navigate environments by reasoning about their surroundings and potential actions. In expert systems, solving the reasoning task 122 can mimic human expertise by incorporating knowledge bases and reasoning mechanisms to provide advice or make decisions. In formal verification for hardware and software systems, solving the reasoning task 122 can generate automatic theorem proofs to verify the correctness of hardware and software systems. In medical diagnosis, solving the reasoning task 122 can assist doctors in diagnosing disease by analyzing patient data and applying medical knowledge through reasoning mechanisms.

The system 100 includes a symbolic engine 104. The symbolic engine 104 uses logical rules and symbolic representations to process information, make inferences, and solve problems based on structured knowledge. The system 100 can use the symbolic engine 104 to generate states 130 for the reasoning task 122. Each state 130 can include a partial solution to the reasoning task. For example, when solving geometry problems, a state 130 can be a true statement generated from a geometric graph for the geometric problem. The system 100 can use the symbolic engine 104 to derive additional partial solutions from a partial solution. After several iterations, the system 100 can find a solution 124 that solves the reasoning task 122.

The system 100 includes a neural language model 102. The neural language model 102 is a generative model that is previously trained on large-scale synthetic data to generate one or more auxiliary data items 106. An auxiliary data item includes additional information or data that are not part of a problem statement of a reasoning task. An auxiliary data item can be introduced to assist the reasoning process by allowing for intermediate calculations, representing complex relationships, or providing extra context and information. For example, in medical diagnosis, an auxiliary data item can include text data describing a suggestion or an advice generated by a neural language model. For example, the suggestion can include performing a computed tomography (CT) scan for the diagnosis of a potential condition or disease. For example, in geometry, an auxiliary construction can be an extra line or circle that can be used to solve a problem or prove a concept.

In some implementations, the neural language model 102 can be trained on large-scale synthetic data using a machine learning training system. For example, by applying a symbolic engine on a diverse set of examples of reasoning tasks, the training system can generate training examples that include hundreds of millions of synthetic states and solutions for example reasoning tasks. Through symbolic deduction and traceback, some training examples can include synthetic search steps that use auxiliary data items. The training system can train the neural language model 102 on the large-scale synthetic data to generate auxiliary data items during a search. During the training, the symbolic engine 104 handles the deduction steps using the generated auxiliary data items. After the training is completed, the neural language model 102 can generate auxiliary data items 106 that can be used for searching a solution 124 to a reasoning task 122.

A generative model is a machine learning (ML) model that generates content, including text, images, audio, or other synthetic data, based on an input. During inference, the generative model can generate a generative output, e.g., a content of a certain type, in response to a query input. In some implementations, the generative model can generate multi-modal outputs, such as an image and a corresponding text describing the image.

In some implementations, the generative model can be configured to process an input sequence of tokens to generate an output sequence of tokens. The tokens can represent any appropriate type of content, e.g., text, image, video, audio, or some combination of the above. For example, the generative model can be a large language model (LLM) and can be configured to process an input sequence of tokens from a vocabulary of text tokens to generate an output sequence of tokens from the vocabulary.

More generally, the generative model can be any appropriate neural network that receives an input sequence that includes text tokens and auto-regressively generates an output sequence that includes text tokens. For example, the generative model can be a Transformer-based language model neural network or a recurrent neural network-based language model neural network.

In some situations, the generative model can be referred to as an auto-regressive neural network when the neural network used to implement the language model auto-regressively generates an output sequence of tokens. More specifically, the auto-regressively generated output is created by generating each particular token in the output sequence conditioned on a current input sequence that includes any tokens that precede the particular token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the generative model can process the current input sequence to generate a score distribution (e.g., a probability distribution) that assigns a respective score, e.g., a respective probability, to each token in a vocabulary of tokens. The language model neural network can then select, as the particular token, a token from the vocabulary using the score distribution. For example, the neural network of the language model can greedily select the highest-scoring token or can sample, e.g., using nucleus sampling or another sampling technique, a token from the distribution.

As a particular example, the generative model can be an auto-regressive Transformer-based neural network that includes (i) a plurality of attention blocks that each apply a self-attention operation and (ii) an output subnetwork that processes an output of the last attention block to generate the score distribution.

The generative model can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J.W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

In some implementations, the generative model can use a decoder-only architecture that includes many decoder blocks, and without using an encoder. Each decoder block can include a self-attention layer and a feed forward neural network. The transformer-based generative model is an example of a generative model that the systems and techniques herein can be applicable.

More generally, the systems and techniques described herein are applicable to other types of generative models. For example, the neural language model 102 can be an auto-regressive generative model that auto-regressively generates tokens representing text data. As another example, the neural language model 102 can be a masked token generative model that sequentially unmasks tokens that represent text data during generation.

The system 100 receives, as input, a problem statement for a reasoning task 122. The problem statement includes text data describing the reasoning task. In some implementations, the problem statement can include a natural language description of the reasoning task. In some implementations, the problem statement can include a description of the reasoning task in a domain specific language (DSL). A DSL is a specialized computer language designed for a particular application domain and is optimized to solve problems within a specific field. A DSL allows for more precise and efficient coding within its specific application domain.

The system 100 can search for a solution 124 to the reasoning task 122 in a loop 101 in which the neural language model 102 and the symbolic engine 104 take turns to run. The search terminates when the solution 124 is found or when the loop 101 reaches a maximum number of iterations.

The neural language model 102 receives the problem statement for the reasoning task 122 as input, and generates text data describing one or more auxiliary data items 106 conditioned on the problem statement and past auxiliary data items. For example, when solving a geometry problem involving a triangle ABC, the neural language model 102 can generate a text output at each iteration, describing an auxiliary construction, such as “construct point X so that ABCX is a parallelogram.” In this example, the auxiliary construction point X is not part of the problem statement of the reasoning task and is introduced to assist the geometric deduction process.

Each time the neural language model 102 generates the one or more auxiliary data items 106, the system 100 can provide the one or more auxiliary data items 106 to the symbolic engine 104.

The symbolic engine 104 can process the one or more auxiliary data items 106 to derive states 130, e.g., partial solutions, and to expand its deduction closure, potentially reaching the solution 124. A deduction closure is a collection of statements where all possible logical conclusions based on those statements are already present within the set itself.

After the symbolic engine 104 generates a deduction closure, the system 100 either arrives at the solution 124 or moves on to the next iteration in the loop 101.

Rather than using a single search process to search for a solution, the system 100 solves the reasoning task 122 by performing multiple different search processes that are parameterized differently. Thus, the system 100 can efficiently explore different parts of a search space for the reasoning task 122 by deploying different search processes in parallel. The system 100 can perform the different search processes in parallel on respective hardware devices. By performing the different search processes in parallel, the system 100 can save computation resources, such processing units, memory, storage, network bandwidth, and battery life. For example, the system can require less memory resources because fewer total search computation steps are necessary by exploring different parts of a search space through parallel searches. In some implementations, the system 100 can run several different beam search trees 114, 116, and 118, in parallel. A beam search is a search algorithm that finds a solution by exploring a graph and expanding the most promising nodes 120 in the graph. In some implementations, the different search processes can use a depth first search, a breadth first search, or any other applicable graph search algorithms.

In some implementations, the multiple different search processes can use different sampling strategies when using the neural language model 102 to generate the auxiliary data item 106. The different sampling strategies of the neural language model 102 can include sampling one auxiliary data item at a time or sampling multiple auxiliary data items at a time. For example, the beam search tree 114 can sample one auxiliary data item 106 at a time, while the beam search tree 116 can sample multiple auxiliary data items 106 at a time. In some implementations, the system 100 can use a sampling strategy that generates different types of auxiliary data items uniformly. For example, the system 100 can prompt the neural language model 102 with an instruction to generate uniform distribution across different types of auxiliary data items. For example, a prompt input to the neural language model 102 can include an instruction asking the neural language model 102 to generate multiple auxiliary constructions that each has a different type. For example, the prompt input to the neural language model 102 can include “x00 a: cong” and “x00 a: coll”, to allow uniform distribution across two types of auxiliary points. The two types of auxiliary points are the “cong” type and the “coll” type. The neural language model 102 can generate the rest of the output for each of the two types of auxiliary points. For example, the output generated by the neural language model 102 can be “x00 a: cong a b c d (00) coll a e f (01),” i.e., constructing point a such that ab=cd and a e f is collinear.

In some implementations, the multiple different search processes can use different search widths, different search depths, or both. In a search algorithm, depth refers to how far down a single branch of a search tree the algorithm explores before backtracking, while width refers to how many nodes at the same level of the tree are explored before moving to the next level down. For example, the beam search tree 116 can be deep and narrow, and the beam search tree 118 can be shallow and wide.

Each search process of the multiple search processes can include multiple iterations. For example, each search process can include a beam search tree. The system 100 can perform beam search in multiple iterations for the multiple nodes of the search tree. Thus, each iteration corresponds to each node in a beam search tree. In some implementations, each node 120 in a search tree can represent a state of the reasoning task. In some implementations, each node can correspond to state data (e.g., a string or an array) for the node and a score indicating a likelihood that the state data is to lead to a solution to the reasoning task 122. The state data for the node can include the problem statement of the reasoning task, a partial solution to the reasoning task, and in some cases some additional information at the current state. The symbolic engine 104 can process the state data for the node to derive additional partial solutions, or arrive at a full solution 124.

For example, each node can represent a proof state. The proof state can include a string (with the problem statement, some additional information, and beginning of the proof), and a number that indicates how likely the string is to lead to a full proof. A symbolic engine can take the string as an input and perform computations to complete the proof. In some implementations, a child node can use an auxiliary data item or a partial solution from an ancestor node (e.g., a parent node or a grandparent node) of the child node. For example, a first node can correspond to a string “construct point X such that AX=BX”, and a second node that follows the first node can correspond to a string “construct point Y such that AY=YX.” Thus, the second node uses the point X from the first node.

In some implementations, at the first iteration of a search process, the system 100 can solve the reasoning task using the symbolic engine 104, without using any auxiliary data items 106. The symbolic engine 104 can derive a deduction closure for the reasoning task 122. The system 100 can determine whether the reasoning task 122 has been solved. If the system 100 determines that the reasoning task has been solved, the system 100 can output the solution 124. If the system 100 determines that the reasoning task has not been solved at the first iteration, e.g., if a solution is not in the deduction closure, the system 100 can move on to the next iteration.

In some implementations, at each intermediate iteration, the system 100 can generate an auxiliary data item 106 at a current iteration using the neural language model 102. The neural language model 102 can process an input including: (i) data for the reasoning task 122, and (ii) one or more auxiliary data items generated at one or more previous iterations to generate one or more auxiliary data items 106 at the current iteration. In some implementations, the neural language model 102 can generate one or more auxiliary data items 106 based on (i) data for the reasoning task 122, (ii) one or more auxiliary data items, and (iii) shared states 112. The maintaining and sharing of the shared states 112 will be discussed later in this specification.

As discussed above, the system 100 can generate, using the symbolic engine 104, states 130 for the reasoning task. The symbolic engine 104 can generate the states 130 using the one or more auxiliary data items 106 at the current iteration and at the one or more previous iterations. The system 100 can determine whether one of the states 130 corresponds to the solution 124 to the reasoning task 122. For example, the system 100 can determine whether the solution is in a deduction closure generated at the current iteration. If the system 100 determines that one of the states 130 corresponds to the solution 124 to the reasoning task 122, the system 100 can terminate the multiple different search processes. The system 100 can provide data describing the solution 124 to the reasoning task 122 for processing.

The system 100 can allow the multiple different search processes to share states among the multiple different search processes through a knowledge sharing mechanism. The system 100 can maintain shared states 112 for the reasoning task 122 generated during the multiple different search processes. For example, the system can store the shared states 112 in a database. The system 100 can share the states 112 for the reasoning task across the multiple different search processes, such as the beam search trees 114, 116, and 118. Therefore, the system 100 can generate the solution 124 to the reasoning task 122 more efficiently and quickly. By sharing states among the multiple different search processes, the system 100 can save computation resources, such processing units, memory, storage, network bandwidth, and battery life relative to performing the multiple different search processes independently. For example, because the states are shared among the different search processes, each search process can complete in fewer steps, saving computation resources, such processing units, memory, storage, network bandwidth, and battery life relative to performing the multiple different search processes independently. As a particular example, the system can perform a search process based on data about the reasoning task saved from another search process, instead of performing the search from scratch, reducing the number of search steps required to arrive at the solution 124.

In some implementations, at an iteration, the system 100 can generate, using the symbolic engine 104, the states 130 for the reasoning task using both the auxiliary data items 106 at the current iteration and at the one or more previous iterations and the shared states 112. The shared states 112 can include states generated during the one or more previous iterations of the search process and generated by one or more other search processes of the multiple different search processes.

For example, after deriving the states 130 using the symbolic engine 104, if the system 100 determines that none of the derived states 130 can provide a solution 124 to the reasoning task 122, the system 100 can select from the states 130 generated using the symbolic engine 104 during the current iteration, a subset of the states for the reasoning task 122. The system can add the selected subset of the states to the states 112 being maintained and shared across the multiple different search processes, such as the beam search trees 114, 116, and 118.

In some implementations, the system 100 can select a subset of the states 130 that are not about a specific auxiliary data item, but broadly relevant to the reasoning task 122. Rather than saving all the states generated by the multiple search processes, the system 100 can save memory and computation because the system only saves a subset of the generated states that are not about a specific auxiliary data item, but are broadly relevant to the reasoning task. Therefore, state information about a specific auxiliary data item that may not be useful for other searches using other auxiliary data items are not saved, thus saving computation resources. That is, relative to a naïve implementation in which all states generated by the search process are saved, by filtering the states to only save relevant states, the system achieves the efficiency gains described above with minimal additional computational overhead, e.g., minimizes how much memory is required to store the data that is shared between search processes. In some implementations, the neural language model 102 can generate the auxiliary data item 106 and a score for the auxiliary data item 106. The score can indicate how relevant the auxiliary data item is to the reasoning task 122. The system 100 can select the subset of the states 130 based on the scores for the auxiliary data items. In some implementations, the system 100 can perform one or more evaluation algorithms that check the states 130 and the auxiliary data items for the states 130 and the system can select the subset of the states 130 based on the result of performing the one or more evaluation algorithms. For example, the system can include an evaluation algorithm that checks the grammar of an auxiliary data item, and other properties of an auxiliary data item. For example, the subset of the states 130 for the reasoning task can be independent of the auxiliary data items 106 at the current iteration and at the one or more previous iterations of a search process. In this way, the subset of the generated facts can be useful for other nodes in the same search process and across different search processes.

For example, based on an auxiliary data item 106, the symbolic engine 104 can generate ten states for a node 120 of a beam search tree 114. Four states can be described without using the auxiliary data item 106. The other six states require using the auxiliary data item 106 to describe them. The system 100 can store the four states that are independent of the auxiliary data items 106 in the database. The system 100 can share the four states across the multiple different beam search trees 114, 116, and 118.

The system 100 can perform the multiple different search processes in parallel using multiple symbolic engine (SE) workers 108 for the symbolic engine 104 and multiple language model (LM) workers 110 for the neural language model 102. In parallel processing, a worker refers to an individual computational unit, like a core of a central processing unit (CPU) or a separate processor, that is assigned a portion of a larger task to execute simultaneously with other workers, allowing for faster overall completion of the task by leveraging multiple processing units. The SE workers 108 can implement multiple copies of the symbolic engine 104 on multiple computation units, such as processors. The LM workers 110 can implement multiple copies of the neural language model 102 on multiple computation units, such as processors. The computation units can be hardware accelerators, such as Tensor Processing Units (TPUs), Graphics Processing Units (GPUs), etc. The symbolic engine 104 and the neural language model 102 can be implemented using different types of hardware devices. For example, the SE workers 108 for the symbolic engine 104 can run on multiple CPUs, while the LM workers 110 for the neural language model 102 can run on multiple GPUs or other hardware accelerators configured to perform neural network operations in hardware, e.g., matrix multiplies in hardware. The system 100 can perform the different search processes in parallel using the multiple SE workers 108 and the multiple LM workers. By performing the different search processes in parallel, the system 100 can save the overall computation resources because the system can efficiently explore different parts of a search space for the reasoning task.

In some implementations, the LM workers 110 can work asynchronously with the SE workers. For example, the LM workers 110 can store the contents of the nodes the LM workers 110 explored to a database, and the SE workers 108 can asynchronously pick up these nodes and work on them. In some implementations, the SE workers 108 can coordinate between themselves to make sure the SE workers 108 divide the work relatively equally.

After generating the solution 124, the system 100 can provide data describing the solution 124 to the reasoning task 122 for processing. For example, the solution 124 can be a proof of a geometric theorem, the system 100 can generate a paragraph and a graph that describes the proof of the geometric theorem. As another example, a solution for a planning system can be a sequence of actions to achieve goals. The system 100 can provide the sequence of actions to the planning system to plan actions.

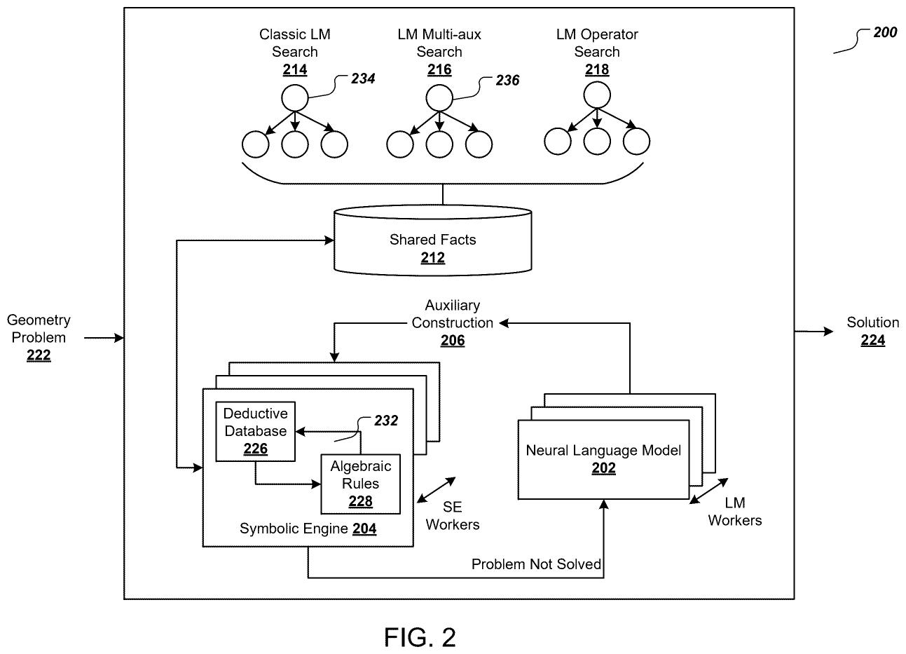

FIG. 2 is a diagram of a neuro-symbolic system 200 for solving geometry problems 222. Proving mathematical theorems can involve logical reasoning and the ability to search through an infinitely large space of actions towards a target. The neuro-symbolic system 200 can generate auxiliary constructions 206 using a neural language model 202. Generating the auxiliary constructions can be the key to the solution 224 to geometry problems 222, and across many mathematical domains. For example, the neuro-symbolic system 200 that uses an auxiliary construction 206 is applicable to proving number theory, solving equations, proving combinatorics, and proving inequality.

The neural language model 202 is trained on large-scale synthetic data using a machine learning training system. Using symbolic engines on a diverse set of random theorem premises, the training system can generate training examples that include hundreds of millions of synthetic theorems and their proofs. Through symbolic deduction and traceback, some training examples can include synthetic proof steps that use auxiliary construction. The training system trains the neural language model 202 on the large-scale synthetic data to generate auxiliary construction during a proof search. During the training, the symbolic engine 204 handles the deduction proof steps using the generated auxiliary proof. After training is completed, the neural language model 202 can effectively generate auxiliary constructions that can be used for searching a solution to a geometry problem.

The symbolic engine 204 can include a deductive database 226 and algebraic rules 228. The symbolic engine 204 can use the deductive database 226 to generate new true statements given the theorem premises of the geometry problem 222. For example, the symbolic engine 204 can use the method of structured deductive database to find a deduction closure given the theorem premises of the geometry problem 222 and if available, one or more auxiliary constructions 206. To further enhance the deduction, the symbolic engine 204 further performs deduction through algebraic rules 228. For example, using the algebraic rules 228, the symbolic engine 204 can perform angle, ratio, or distance chasing. The symbolic engine 204 can use a Gaussian elimination process to find a deduction closure for all possible linear operators. The symbolic engine 204 alternates the deductive database 226 and the algebraic rules 228 in a loop 232 to expand the joint closure of known true statements until expansion halts, e.g., arriving at a deduction closure.

The system 200 can perform multiple different beam searches in parallel to efficiently explore different parts of the search space. The system 200 can perform the different beam searches in parallel on respective hardware devices. Thus, by leveraging parallelization, the system greatly reduces the latency required to perform the multiple beam searches. The system can deploy multiple search trees, such as a classic language model (LM) search tree 214, a LM multi-aux search tree 216, and a LM operator search tree 218. In some implementations, the system can use a search tree with one or more midpoints, or a search tree with any other heuristics. Other types of search methods are possible.

The classic LM search tree 214 is a simple beam search tree. The neural language model 202 generates k different sequences describing k auxiliary constructions 206. The classic LM search tree 214 performs a beam search over these k auxiliary constructions 206, using the score of each beam as its value function. The score is generated from a language model, such as the neural language model 102. The score of each beam can be the length-normalized probability score. For example, the score of each beam can be a conditional probability conditioned on the problem statement of the geometry problem 222 and past construction. The search across the beams is parallelizable. Each node 234 of the classic LM search tree performs the search using a single auxiliary construction 206.

The LM multi-aux search tree 216 predicts multiple auxiliary constructions 206 at each node 236. Instead of producing one auxiliary data item per node (as in the classic LM search tree), the LM multi-aux search tree 216 can produce multiple auxiliary constructions 206 at one node.

The LM operator search tree 218 performs operator search. The system 200 can prompt the neural language model 202 to produce a specific auxiliary construction 206. For example, the system 200 can provide an input prompt to the neural language model 202 and the input prompt can be “construct a point a which is a midpoint . . . ” The neural language model 202 can complete the sentence and can determine points for which a is a midpoint.

In some implementations, the multiple different beam searches can include a LM search tree that predicts different types of auxiliary constructions non-uniformly. For example, a prompt input to the neural language model 202 can include an instruction asking the neural language model 202 to generate a point type construction. For example, the prompt input can be a token of “x00”, and the neural language model 202 can generate “x00 a: cong a b c d (00) coll a e f (01)”, describing a construction point a such that ab=cd and the points a, e, and f are collinear.

In some implementations, the multiple different beam searches can include a LM search tree that predicts different types of auxiliary constructions uniformly. For example, a prompt input to the neural language model 202 can include an instruction asking the neural language model 202 to generate multiple auxiliary constructions that each has a different type. For example, the prompt input can be “x00 a: cong”, “x00 a: coll”, “x00 a: cyclic”, “x00 a: perp”, to allow uniform distribution across the four types of tokens.

In some implementations, an LM search tree can be a deep and narrow tree. In some implementations, an LM search tree can be a shallow and wide tree. The depth of a search tree can be the number of layers in the tree. The width of a search tree can be the number of nodes in each layer. The system can implement search trees with different depths and/or widths by varying the number of layers and/or the number of nodes in each layer.

The system 200 can allow the multiple different beam searches to share states among the multiple different beam searches through a knowledge sharing mechanism. The system 200 maintains facts 212 generated by the multiple different beam searches and shares the facts 212 among the multiple different beam searches. For example, the multiple search trees 214, 216, and 218 can store the facts 212 they managed to prove in a database and the system 100 can share the facts 212 to the multiple search trees 214, 216, and 218. For example, a search from a node of the search tree 214 can generate data for one piece of fact about the geometry problem 222, and the system can store the data for the fact in a database of the system 200. When the search tree 214 or another search tree 216 performs a subsequent iteration of search on another node of the tree, the symbolic engine 204 can access the data for the fact and can perform derivation based on the fact.

In each search tree of the multiple different beam searches, a node of the search tree can correspond to one attempt at generating one or more auxiliary constructions 206 and one attempt of generating a deduction closure using the symbolic engine 104, e.g., by running the loop 232 of deductive database 226 and algebraic rules 228. If the attempt succeeds, e.g., a solution is found in the deductive closure, system 200 can terminate the multiple different beam searches. If the attempt fails, the system 200 can store facts that the symbolic engine 204 managed to prove as shared facts 212 in a database. The shared facts can include facts in the deduction closure generated by the symbolic engine 204. The system 200 can choose the shared facts 212 that are not about a particular auxiliary construction associated with a specific node, but facts that are relevant to the geometry problem 222. In this way, the shared facts 212 can be useful for other nodes in the same search tree and across different search trees.

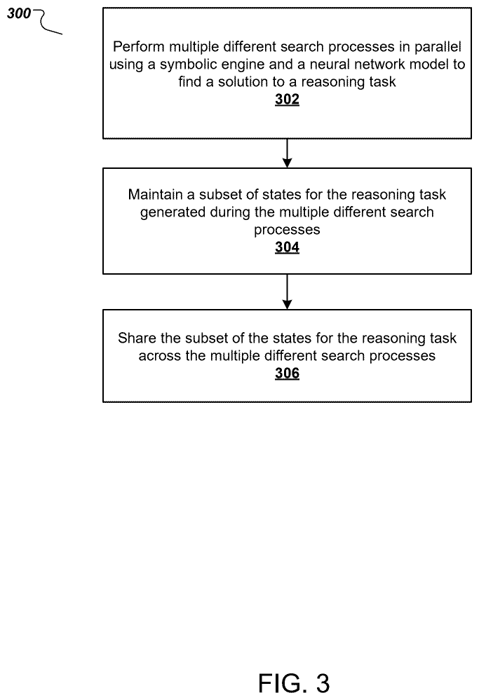

FIG. 3 is a flow chart of an example process 300 for performing multiple different search processes in parallel. The process 300 will be described as being performed by an appropriately programmed computer system, such as the system 100.

The system performs multiple different search processes in parallel using a symbolic engine and a neural network model to find a solution to a reasoning task (302). Each search process of the multiple different search processes can include multiple iterations. The system can perform the different search processes in parallel on respective hardware devices. By performing the different search processes in parallel, the system can save computation resources, such processing units, memory, storage, network bandwidth, and battery life. For example, the system can require less memory resources because fewer total search computation steps are necessary by exploring different parts of a search space through parallel searches.

In some implementations, the multiple different search processes can use different sampling strategies when using the neural network model to generate the auxiliary data item at the current iteration. In some implementations, the multiple different search processes can use different search widths, different search depths, or both. In some implementations, the multiple different search processes can include multiple different beam search trees, and each iteration can be a node of a beam search tree of the multiple different beam search trees.

In some implementations, the reasoning task can be a mathematical problem, and the auxiliary data item can be an auxiliary construction for the mathematical problem. For example, the mathematical problem can be a geometry problem, a number theory problem, a problem for solving an equation, a problem for proving combinatorics, or a problem for proving inequality.

The system maintains a subset of the states for the reasoning task generated during the multiple different search processes (304). Rather than maintaining all the states generated by the multiple search processes, the system can save memory and computation because the system only maintains a subset of the generated states that are not about a specific auxiliary data item, but are broadly relevant to the reasoning task. Therefore, state information about a specific auxiliary data item that may not be useful for other searches using other auxiliary data items are not saved, thus saving computation resources.

The system shares the subset of the states for the reasoning task across the multiple different search processes (306). By sharing states among the multiple different search processes, the system 100 can save computation resources, such processing units, memory, storage, network bandwidth, and battery life. For example, the system can save the amount of computation needed because facts about the reasoning task can be shared between the multiple different search processes. The system can perform a search process based on known facts about the reasoning task saved from another search process, instead of performing the search from scratch.

The system can store the subset of states in a database that is accessible by the multiple different search processes. In some implementations, the system can maintain data or information generated by the multiple different search processes and can share the data or information among the multiple different search processes. For example, each search tree of the multiple search trees can store the facts they managed to prove in a database and the system can share the facts among the multiple search trees. For example, a search from a node of a first search tree can generate data for one piece of fact about the reasoning task, and the system can store the data for the fact in a database of the system. When the first search tree or another search tree performs a subsequent iteration of search on another node of the tree, the symbolic engine can access the data for the fact and can generate a state (e.g., a partial solution) for the reasoning task based on the fact.

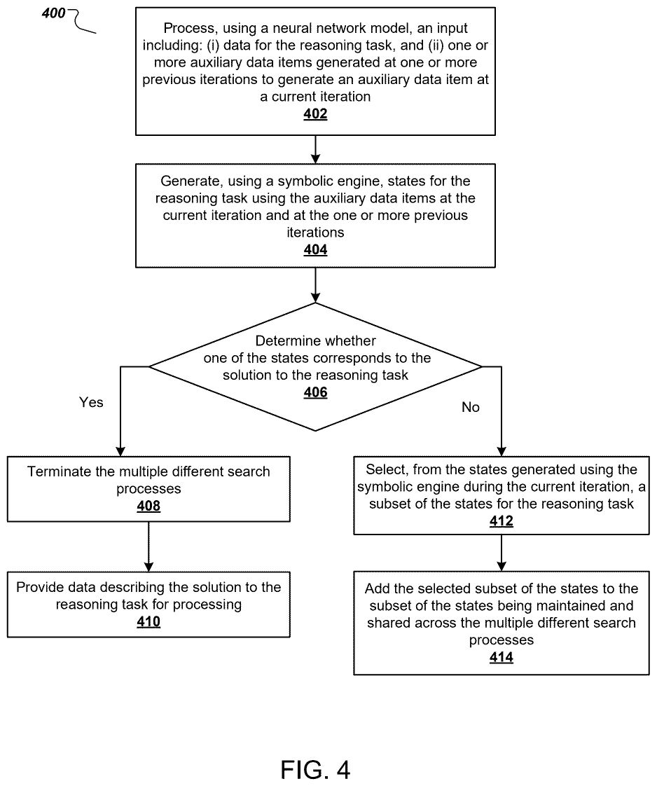

FIG. 4 is a flow chart of an example process 400 for performing a search at one iteration of a search process. The process 400 will be described as being performed by an appropriately programmed computer system, such as the system 100.

The system processes using the neural network model, an input including: (i) data for the reasoning task, and (ii) one or more auxiliary data items generated at one or more previous iterations to generate an auxiliary data item at a current iteration (402).

The system generates, using the symbolic engine, states for the reasoning task using the auxiliary data items at the current iteration and at the one or more previous iterations (404). In some implementations, the system can generate, using the symbolic engine, the states for the reasoning task using (i) the auxiliary data items at the current iteration and at the one or more previous iterations, and (ii) the subset of the states generated during the one or more previous iterations of the search process and generated by one or more other search processes of the multiple different search processes. For example, the system can maintain and share a subset of the states generated during one or more previous iterations of the search process. The system can maintain and share a subset of the states generated by one or more other search processes. The system can use the neural language model to generate one or more auxiliary data items at the current iteration. The system can use the symbolic engine to generate states for the reasoning task at the current iteration using (i) the one or more auxiliary data items at the current iterations, and (ii) the subset of the states maintained and shared by the system.

The system determines whether one of the states corresponds to the solution to the reasoning task (406). In some implementations, the system can determine whether the solution is in a deduction closure generated at the current iteration. For example, when the reasoning task is to prove three points A, B, and C are on the same line, the symbolic engine can check, within its internal database of deductions, whether there exists a line that contains all three points A, B, and C.

In response to determining that one of the states corresponds to the solution to the reasoning task, the system terminates the multiple different search processes (408).

The system provides data describing the solution to the reasoning task for processing (410). In some implementations, the system can display the data describing the solution to the reasoning task on a user interface of a display. In some implementations, the system can provide data describing the solution to the reasoning task to another system for subsequent processing.

In response to determining that none of the states corresponds to the solution to the reasoning task, the system selects from the states generated using the symbolic engine during the current iteration, a subset of the states for the reasoning task (412).

The system adds the selected subset of the states to the subset of the states being maintained and shared across the multiple different search processes (414).

In some implementations, the subset of the states for the reasoning task can be independent of the auxiliary data items at the current iteration and at the one or more previous iterations.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, off-the-shelf or custom-made parallel processing subsystems, e.g., a GPU or another kind of special-purpose processing subsystem. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
performing multiple different search processes in parallel using a symbolic engine and a neural network model to find a solution to a reasoning task, wherein each search process of the multiple different search processes comprises multiple iterations, and at each iteration, performing the search process comprises:
processing, using the neural network model, an input comprising: (i) data for the reasoning task, and (ii) one or more auxiliary data items generated at one or more previous iterations to generate an auxiliary data item at a current iteration; and
generating, using the symbolic engine, states for the reasoning task using the auxiliary data items at the current iteration and at the one or more previous iterations;
maintaining a subset of the states for the reasoning task generated during the multiple different search processes; and
sharing the subset of the states for the reasoning task across the multiple different search processes.

2. The method of claim 1, wherein at one iteration, performing the search process comprises:
after generating the states for the reasoning task using the auxiliary data items at the current iteration and at the one or more previous iterations, determining whether one of the states corresponds to the solution to the reasoning task;
in response to determining that one of the states corresponds to the solution to the reasoning task, terminating the multiple different search processes; and
providing data describing the solution to the reasoning task for processing.

3. The method of claim 1, wherein at another iteration, performing the search process comprises:
after generating the states for the reasoning task using the auxiliary data items at the current iteration and at the one or more previous iterations, determining whether one of the states corresponds to the solution to the reasoning task;
in response to determining that none of the states corresponds to the solution to the reasoning task, selecting, from the states generated using the symbolic engine during the current iteration, a subset of the states for the reasoning task; and
adding the selected subset of the states to the subset of the states being maintained and shared across the multiple different search processes.

4. The method of claim 1, wherein the reasoning task is a mathematical problem, and the auxiliary data item is an auxiliary construction for the mathematical problem.

5. The method of claim 1, wherein the multiple different search processes use different sampling strategies when using the neural network model to generate the auxiliary data item at the current iteration.

6. The method of claim 1, wherein the multiple different search processes use different search widths, different search depths, or both.

7. The method of claim 1, wherein the subset of the states for the reasoning task is independent of the auxiliary data items at the current iteration and at the one or more previous iterations.

8. The method of claim 1, wherein at each iteration of each search process of the multiple different search processes, generating, using the symbolic engine, the states for the reasoning task comprises:
generating, using the symbolic engine, the states for the reasoning task using (i) the auxiliary data items at the current iteration and at the one or more previous iterations, and (ii) the subset of the states generated during the one or more previous iterations of the search process and generated by one or more other search processes of the multiple different search processes.

9. The method of claim 1, wherein the multiple different search processes comprise multiple different beam search trees, and each iteration is a node of a beam search tree of the multiple different beam search trees.

10. A system comprising one or more computers and one or more storage devices storing instructions that are operable, when executed by the one or more computers, to cause the one or more computers to perform operations comprising:
performing multiple different search processes in parallel using a symbolic engine and a neural network model to find a solution to a reasoning task, wherein each search process of the multiple different search processes comprises multiple iterations, and at each iteration, performing the search process comprises:
processing, using the neural network model, an input comprising: (i) data for the reasoning task, and (ii) one or more auxiliary data items generated at one or more previous iterations to generate an auxiliary data item at a current iteration; and
generating, using the symbolic engine, states for the reasoning task using the auxiliary data items at the current iteration and at the one or more previous iterations;
maintaining a subset of the states for the reasoning task generated during the multiple different search processes; and
sharing the subset of the states for the reasoning task across the multiple different search processes.

11. The system of claim 10, wherein at one iteration, performing the search process comprises:
after generating the states for the reasoning task using the auxiliary data items at the current iteration and at the one or more previous iterations, determining whether one of the states corresponds to the solution to the reasoning task;
in response to determining that one of the states corresponds to the solution to the reasoning task, terminating the multiple different search processes; and
providing data describing the solution to the reasoning task for processing.

12. The system of claim 10, wherein at another iteration, performing the search process comprises:
after generating the states for the reasoning task using the auxiliary data items at the current iteration and at the one or more previous iterations, determining whether one of the states corresponds to the solution to the reasoning task;
in response to determining that none of the states corresponds to the solution to the reasoning task, selecting, from the states generated using the symbolic engine during the current iteration, a subset of the states for the reasoning task; and
adding the selected subset of the states to the subset of the states being maintained and shared across the multiple different search processes.

13. The system of claim 10, wherein the reasoning task is a mathematical problem, and the auxiliary data item is an auxiliary construction for the mathematical problem.

14. The system of claim 10, wherein the multiple different search processes use different sampling strategies when using the neural network model to generate the auxiliary data item at the current iteration.

15. The system of claim 10, wherein the multiple different search processes use different search widths, different search depths, or both.

16. The system of claim 10, wherein the subset of the states for the reasoning task is independent of the auxiliary data items at the current iteration and at the one or more previous iterations.

17. The system of claim 10, wherein at each iteration of each search process of the multiple different search processes, generating, using the symbolic engine, the states for the reasoning task comprises:
generating, using the symbolic engine, the states for the reasoning task using (i) the auxiliary data items at the current iteration and at the one or more previous iterations, and (ii) the subset of the states generated during the one or more previous iterations of the search process and generated by one or more other search processes of the multiple different search processes.

18. The system of claim 10, wherein the multiple different search processes comprise multiple different beam search trees, and each iteration is a node of a beam search tree of the multiple different beam search trees.

19. One or more non-transitory storage media encoded with instructions that when executed by a computing device cause the computing device to perform operations comprising:
performing multiple different search processes in parallel using a symbolic engine and a neural network model to find a solution to a reasoning task, wherein each search process of the multiple different search processes comprises multiple iterations, and at each iteration, performing the search process comprises:
processing, using the neural network model, an input comprising: (i) data for the reasoning task, and (ii) one or more auxiliary data items generated at one or more previous iterations to generate an auxiliary data item at a current iteration; and
generating, using the symbolic engine, states for the reasoning task using the auxiliary data items at the current iteration and at the one or more previous iterations;
maintaining a subset of the states for the reasoning task generated during the multiple different search processes; and
sharing the subset of the states for the reasoning task across the multiple different search processes.

20. The non-transitory storage media of claim 19, wherein at one iteration, performing the search process comprises:
after generating the states for the reasoning task using the auxiliary data items at the current iteration and at the one or more previous iterations, determining whether one of the states corresponds to the solution to the reasoning task;
in response to determining that one of the states corresponds to the solution to the reasoning task, terminating the multiple different search processes; and
providing data describing the solution to the reasoning task for processing.
